(19) United States
(12) Patent Application Publication
(10) Pub. No.: US 2010/0227585 A1
(43) Pub. Date: Sep. 9, 2010

(54) METHOD AND APPARATUS FOR TRANSMISSION OF EMERGENCY INFORMATION FROM EMERGENCY PERSONNEL

(75) Inventors: Jonathan Briggs CARROLL, Broomfield, CO (US); Christopher J. MEYER, Thomton, CO (US)

Correspondence Address: PRASS LLP, 2661 Riva Road, Bldg. 1000, Suite 1044, ANNAPOLIS, MD, 21401, US

(73) Assignee: LOCKHEED MARTIN CORPORATION, Bethesda, MD (US)

(21) Appl. No.: 12/398,400

(22) Filed: Mar. 5, 2009

(51) Int. Cl. H04M 11/04; H04B 7/00; G08B 1/08

(52) U.S. Cl. 455/404.2; 455/41.2; 340/539.13

(57) ABSTRACT

A method, apparatus and system that transmits emergency information to an emergency response center is disclosed. The system may include an actuator unit located at a first location on an emergency personnel member that may receive an actuation signal from the actuator button, retrieve the emergency personnel member's data file from the memory, and signal the first transmitter to transmit the actuation signal and the emergency personnel member's data file to a communication device located at a second location on the emergency personnel member. The system also includes a communication device that receives position information concerning the emergency personnel member from the positional information receiver, calculates the emergency personnel member's position based on the received position information, and sends a signal to the second transmitter to transmit the calculated emergency personnel member's position, the emergency personnel member's data file, and an actuation signal notification to the emergency response center.

### BACKGROUND OF THE DISCLOSURE

1. Field of the Disclosure

The disclosure relates to a method and apparatus for transmission of emergency messages from emergency personnel.

2. Introduction

Dangerous situations, decisions, and dire consequences may face emergency personnel, such as military, fire, law enforcement, etc., at a moment's notice. Calls to unknown situations can quickly escalate beyond control when such personnel are called in for assistance and arrive on scene. These situations are dangerous for the responding emergency personnel and it may become difficult to radio for backup assistance. Furthermore, if these personnel become injured and are in need of medical assistance, they may be out of visual or video contact from other personnel and may be incapable of communicating their status via radio, cell phone, etc.

### SUMMARY OF THE DISCLOSURE

A method, apparatus and system that transmits emergency information to an emergency response center is disclosed. The system may include an actuator unit located at a first location on an emergency personnel member that may receive an actuation signal from the actuator button, retrieve the emergency personnel member's data file from the memory, and signal the first transmitter to transmit the actuation signal and the emergency personnel member's data file to a communication device located at a second location on the emergency personnel member. The system also includes a communication device that receives position information concerning the emergency personnel member from the positional information receiver, calculates the emergency personnel member's position based on the received position information, and sends a signal to the second transmitter to transmit the calculated emergency personnel member's position, the emergency personnel member's data file, and an actuation signal notification to the emergency response center.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is a diagram of an exemplary emergency information communication network environment in accordance with a possible embodiment of the disclosure;

FIG. 2 is a diagram of an exemplary emergency information transmission system in accordance with a possible embodiment of the disclosure;

FIG. 3 is a block diagram of an exemplary actuator unit in accordance with a possible embodiment of the disclosure;

FIG. 4 is a block diagram of an exemplary communication device in accordance with a possible embodiment of the disclosure;

FIG. 5 is a block diagram of an exemplary emergency response center server in accordance with a possible embodiment of the disclosure;

FIG. 6 is an exemplary flowchart illustrating a possible actuation signal process in accordance with one possible embodiment of the disclosure; and

FIG. 7 is an exemplary flowchart illustrating a possible emergency information transmission process in accordance with one possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure may comprise a variety of embodiments, such as a method and apparatus and other embodiments that relate to the basic concepts of the disclosure. This disclosure may concerns a method and apparatus for transmission of emergency messages from emergency personnel. Emergency personnel may include military, law enforcement, fire, and other rescue personnel. The boots issued to emergency personnel are one of the standard items of their uniform. The boots are ideal for this implementation for numerous reasons. First, the boot facilitates the placement of the Global Positioning System (GPS) and cell phone chip in an inconspicuous place while providing the safest position for protection from the outside environment. The second advantage is the relatively long length of the antenna the boot facilitates by running the line up the back stitching of the boot; thus reducing the amount of power required to generate a signal.

The U.S. Government recently instituted a federally mandated update to the 911 system to support the location of individuals who dial 911 from their cell phones. The effort is call E911. Enhanced 911 (E911) locks onto the signal and keeps the line open to locate the caller using the location information broadcasted by the phone to the call center. The system described in the disclosed embodiments may communicate with the 911 call center to identify itself as emergency personnel. The 911 call center may use this information to dispatch backup and bring rescue personnel on standby or response in accordance with the department's policy. As part of the proposed implementation, it is anticipated that 911 software modifications or updates may have to be developed to correctly identify the chip's data transmission as emergency personnel and correctly route the data within the emergency call centers.

The chip may give its location based upon the signal strength it receives from the communicating towers to triangulate its position and send that information to the 911 center. Triangulation is a process by which the location of a radio transmitter can be determined by measuring either the radial distance, or the direction, of the received signal from two or three different points. Triangulation may be used in cellular communications to pinpoint the geographic position of a user. The distance may be calculated based on signal strength of the corresponding towers and a location is plotted. This information may be relayed between the cell towers to fix the position of the cell phone user and used to automatically coordinate tower hand-off to maintain the callers signal and may be used by the E911 system to track the movement of the caller.

With respect to GPS capabilities, in a clear sky anywhere in the continental United States, a GPS receiver can see enough satellites in orbit to accurately calculate its relative position on Earth. This technology has been instituted in the cell phone market and has boasted an accuracy of a few meters in commercial applications which is well within visual distance for backup and rescue personnel.

A single chip may receive a GPS signal and/or the GPS information from the cell tower. The chip may use this information and combine it with the triangulation data to broadcast an increasingly accurate location to the 911 emergency centers.

Any known power source may be used, such as lithium-ion batteries, for example. Given their structure and purpose, the disclosed embodiments need less power than the typical cell phone. The chip may only need to establish the data transmission to the call center and may not need to provide voice or video capability. Since the boot will be in sleep-mode for the majority of the time, the boot may only need to be recharged once every 3-4 months. Recharging may be accomplished utilizing an environmentally secured USB outlet, for example. This outlet may keep the components secure from the elements and may provide the required capability to recharge the board.

The integrated circuit may include an encryption transmitter/receiver that may be capable of over one million unique activation codes, for example. Using the proper protocol in conjunction with an encoder/decoder, allows an encrypted transmission to occur between an activation device on one part of the emergency personnel's uniform, such as the belt, and another part of the uniform, such as the boot and its integrated chip. Encryption may ensure that no accidental activation of the chip takes place and may ensure that only one emergency personnel may activate just their own boot.

For maintenance purposes, the emergency personnel may engage a selector switch on the actuator to perform a daily or weekly (periodic) functions check to ensure the communication device is in operation. A vibration motor may be attached to the circuit board in the heal and may vibrate a set number of times on the inside achilles heel, for example, to indicate that the unit is functioning normally.

So as an example of how this process may work, a police officer wearing the devices described in the disclosed embodiments, when in distress, may depress the activation switch located on his belt or vest, for example. The actuator may send an encrypted activation signal to a receiver in the officer's boot. The boot, utilizing GPS and cell phone triangulation, may send a distress signal over the E911 system. The digital code sequence may interface with the 911 call center and identify the signal as an officer in distress. The dispatcher may then forward the information to all officers in the responding area for backup and provide GPS coordinates of the officer in distress.

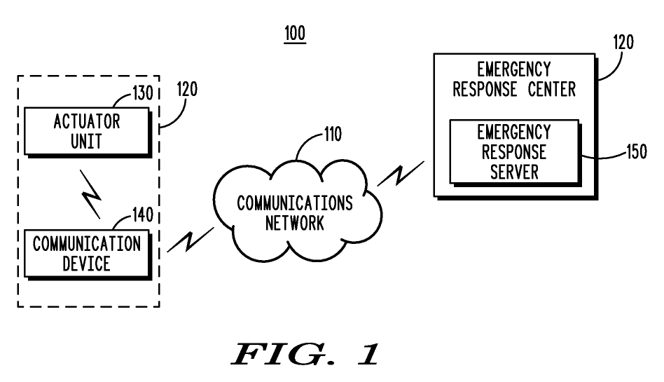

FIG. 1 is a diagram of an exemplary emergency information communication network environment 100 in accordance with a possible embodiment of the disclosure. In particular, the exemplary emergency information communication network environment 100 may include an emergency information transmission system 120 and an emergency response center 160 connected through a communications network 110. The emergency information transmission system 120 may include an actuator unit 130 and a communication device 140.

The emergency response center 160 may include one or more emergency response servers 150 to process emergency information. The emergency response center 160 may represent any entity civilian or military that may receive distress, emergency, rescue, or backup calls from emergency personnel members, such as fire, police, armed services, or other rescue or law enforcement personnel. Based on the emergency information received, the emergency response server 150 at the emergency response center 160 may then provide the information to the proper authorities for responsive action or initiate such action itself.

Communications network 110 may represent any possible communications network that may handle telephonic communications, including wireless telephone networks, hardwired telephone networks, wireless local area networks (WLAN), the Internet, an intranet, etc., for example.

The emergency response server 150 may represent a server, a computer, a personal computer, a portable computer, or a personal digital assistant, for example, that is located at an emergency response center 160 and may process emergency information received from communication devices 140.

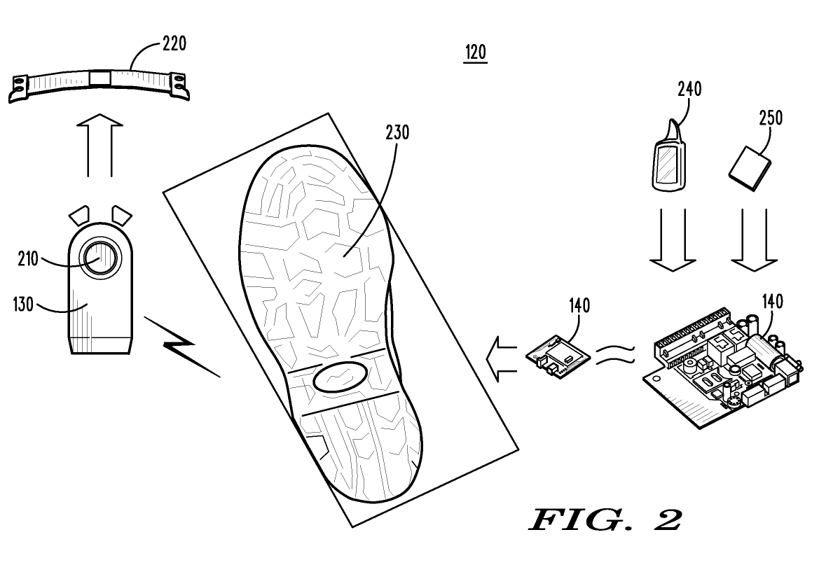

FIG. 2 is a diagram of an exemplary emergency information transmission system 120 in accordance with a possible embodiment of the disclosure. The emergency information transmission system 120 may include actuator unit 130 and communication device 140. Actuator unit 130 may be located at any first location on an emergency personnel member, such as a belt 220, or on another clothing article, such as a vest, or a wristband, for example. The communication device 140 may be located on a second location (different from the first location) on the emergency personnel member, such as a boot 230, for example, or on another clothing article, such as a vest (if the actuator unit is not located there), or an ankle bracelet, for example. One of skill in the art may appreciate that other locations on the emergency personnel member's clothing or accessories may be used within the spirit and scope of the invention as long as the actuator unit 130 and the communication device 140 are not co-located.

The actuator unit 130 may contain an actuator button 210 that an emergency personnel member may press when he or she is in distress or needs backup or medical assistance, for example. The communication device 140 may be a circuit board that includes a transmitter 240 and a positional information receiver 250. Transmitter 240 maybe any transmitter that hay transmit information through any communication network 110, including a cellular transmitter, for example. Positional information receiver 250 may be any chip that may receive positional information from positional information sources, such as a global positioning system (GPS) satellite or ground station, or cellular tower signals, for example. The positional information receiver 250 may use triangulation from any combination of GPS or cellular tower information to compute the position of the emergency personnel member.

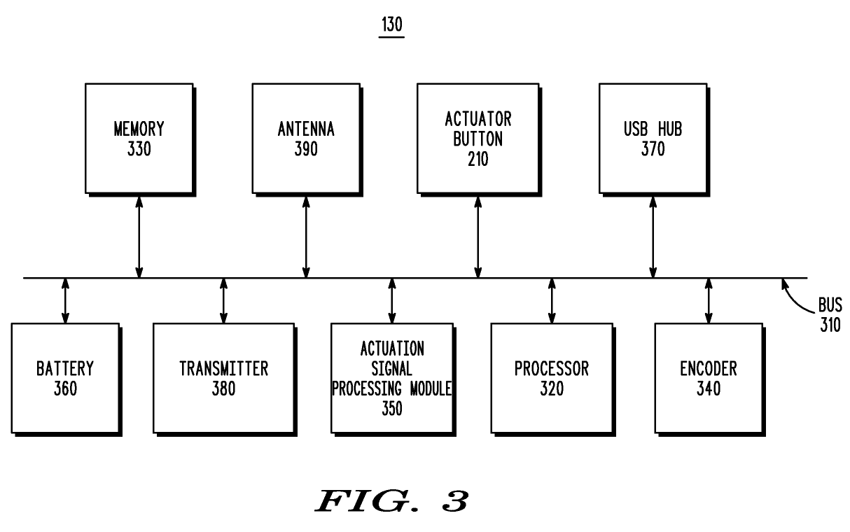

FIG. 3 is a block diagram of an exemplary actuator unit 130 in accordance with a possible embodiment of the disclosure. The exemplary actuator unit 130 may include bus 310, actuation button 210, processor 320, memory 330, encoder 340, actuation signal processing module 350, battery 360, universal service bus (USB) pub 370, transmitter 380, and antenna 390. Bus 310 may permit communication among the components of the actuator unit 130.

Processor 320 may be any controller or processing device and may include at least one conventional processor, microprocessor, EEPROM, etc. that interprets and executes instructions. Memory 330 may be a random access memory (RAM or another type of dynamic storage device that stores information and instructions for execution by processor 320. Memory 330 may also include a read-only memory (ROM) which may include a conventional ROM device or another type of static storage device that stores static information and instructions for processor 320.

Encoder 340 maybe any software or hardware mechanism that may encode information and signals prior to transmission. Battery 360 may represent any portable rechargeable or unrechargeable power source to power the actuator unit 130. The USB hub 370 may be used to download and update emergency personnel member data files into memory 330. In addition, the USB hub 370 may also be used to recharge the battery 360.

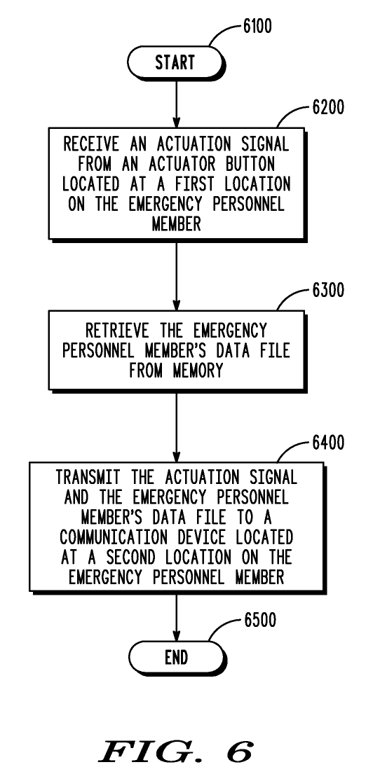

The transmitter 380 may represent any transmitter that may transmit signals and information to the communication device 140. The transmitter 380 may use Bluetooth technology, for example. Antenna 390 may be any antenna device that may receive signals from the transmitter 380 and facilitate transmission of information and signals to the communication device 140. The antenna 390 may be a Bluetooth antenna for example. The operation of the actuation signal processing module 350 will discussed below in relation to FIG. 6.

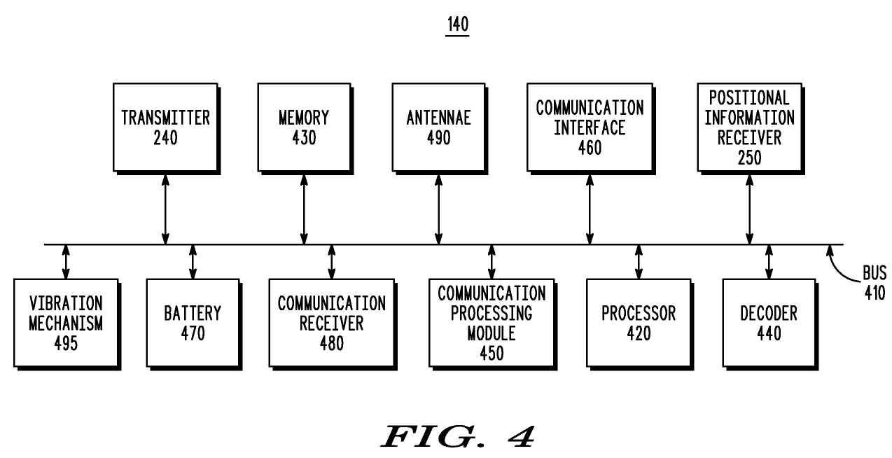

FIG. 4 is a block diagram of an exemplary communication device 140 in accordance with a possible embodiment of the disclosure. The exemplary communication device 140 may include bus 410, processor 420, memory 430, decoder 440, communication processing module 450, communication interface 460, battery 470, communications receiver 480, antenna 490, vibrating mechanism 495, transmitter 240, and positional information receiver 250. Bus 410 may permit communication among the components of the communication device 140.

Processor 420 may be any controller or processing device and may include at least one conventional processor, microprocessor, EEPROM, etc. that interprets and executes instructions. Memory 430 may be a random access memory (RAM or another type of dynamic storage device that stores information and instructions for execution by processor 420. Memory 430 may also include a read-only memory (ROM) which may include a conventional ROM device or another type of static storage device that stores static information and instructions for processor 420.

Decoder 440 maybe any software or hardware mechanism that may decode encoded information and signals upon reception. Battery 470 may represent any portable rechargeable or unrechargeable power source to power the communication device 140. Antennae 490 may be one or more antenna device that may receive signals from the transmitter 240, GPS satellite, GPS ground station, cellular tower, etc. and facilitate transmission of information and signals to the emergency response center 160 or other destinations via the communications network 110.

Communication interface 460 may include any mechanism that facilitates communication via a network. For example, communication interface 380 may include a modem. Alternatively, communication interface 460 may include other mechanisms for assisting in communications with other devices and/or systems. Communications receiver 480 may be any receiver or transceiver capable of receiving information and signals from the actuator unit 130, such as a Bluetooth receiver, for example.

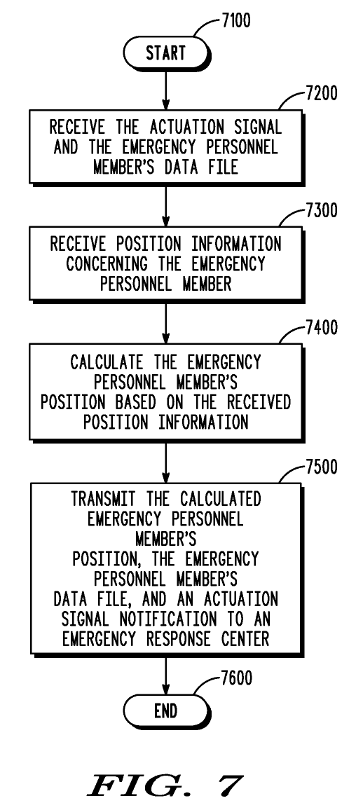

Vibration mechanism 495 maybe any device that vibrates upon receiving a test signal. The test signal may be generated at the actuator unit 130, for example, to test the communication ability and status between the actuator unit 130 and the communication device 140. The actuator button 210 or another testing button may be pressed in a testing mode to activate the vibration mechanism 495. If the vibration mechanism 495 vibrates in this test mode, then the test is a success and the emergency personnel member will have a level of assuredness that the emergency information communication system 120 is operating properly. The operation of the communication processing module 450 will be discussed below in relation to FIG. 7.

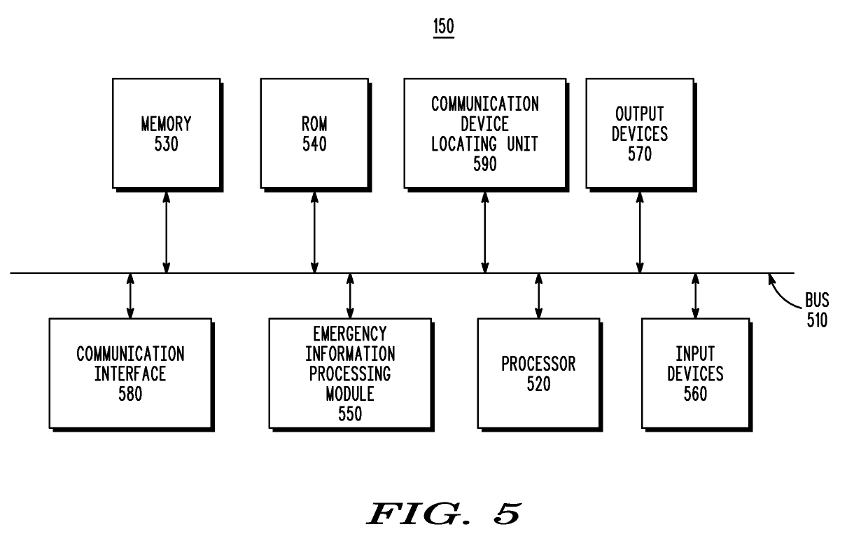

FIG. 5 is a block diagram of an exemplary emergency response center server 150 in accordance with a possible embodiment of the disclosure. The exemplary emergency response center server 150 may include bus 510, processor 520, memory 530, ROM four 540, emergency information processing module 550, input devices 560, output devices 570, indication in the interface 580, and communication device locating unit 590. Bus 310 may permit communication among the components of the emergency response center server 150.

Processor 520 may be any controller or processing device and may include at least one conventional processor, microprocessor, EEPROM, etc. that interprets and executes instructions. Memory 530 may be a random access memory (RAM or another type of dynamic storage device that stores information and instructions for execution by processor 520. Memory 530 may also include a read-only memory (ROM) which may include a conventional ROM device or another type of static storage device that stores static information and instructions for processor 520.

Communication interface 580 may include any mechanism that facilitates communication via a network. For example, communication interface 580 may include a modem. Alternatively, communication interface 580 may include other mechanisms for assisting in communications with other devices and/or systems.

ROM 540 may include a conventional ROM device or another type of static storage device that stores static information and instructions for processor 520. A storage device may augment the ROM and may include any type of storage media, such as, for example, magnetic or optical recording media and its corresponding drive.

Input devices 560 may include one or more conventional mechanisms that permit a user to input information to the emergency response center server 150, such as a keyboard, a mouse, a pen, a voice recognition device, touchpad, buttons, etc. Output devices 570 may include one or more conventional mechanisms that output information to the user, including a display, a printer, a copier, a scanner, a multi-function device, one or more speakers, or a medium, such as a memory, or a magnetic or optical disk and a corresponding disk drive.

The emergency information processing module 550 may process received actuation notification signals, emergency personnel member data files, and other emergency information and initiate proper actions in response. For example, the emergency information processing module 550 may contact other emergency rescue entities for backup, medical treatment, or other necessary actions to protect and aid emergency personnel members in the field. The communication device locating unit 590 may receive and process the computed position information concerning the emergency personnel member to assist backup, rescue and medical personnel to pinpoint the emergency personnel member and direct other emergency personnel to his or her location.

The emergency response center server 150 may perform such functions in response to processor 520 by executing sequences of instructions contained in a computer-readable medium, such as, for example, memory 530. Such instructions may be read into memory 530 from another computer-readable medium, such as a storage device or from a separate device via communication interface 580.

The emergency response center server 150 illustrated in FIGS. 1 and 5 and the related discussion are intended to provide a brief, general description of a suitable communication and processing environment in which the invention may be implemented. Although not required, the invention will be described, at least in part, in the general context of computer-executable instructions, such as program modules, being executed by the emergency response center server 150, such as a communication server, communications switch, communications router, or general purpose computer, for example.

Generally, program modules include routine programs, objects, components, data structures, etc. that perform particular tasks or implement particular abstract data types. Moreover, those skilled in the art will appreciate that other embodiments of the invention may be practiced in communication network environments with many types of communication equipment and computer system configurations, including personal computers, hand-held devices, multi-processor systems, microprocessor-based or programmable consumer electronics, and the like.

Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

FIG. 6 is an exemplary flowchart illustrating a possible actuation signal process in accordance with one possible embodiment of the disclosure. The process begins at step 6100 and continues to step 6200 where the actuation signal processing module 350 may receive an actuation signal from the actuator button 210 located at a first location on the emergency personnel member. At step 6300, the actuation signal processing module 350 may retrieve the emergency personnel member's data file from the memory 330. The emergency personnel member's data file may include personal identification information, emergency personnel unit identification, blood type, health information, allergies, health conditions, medical history, current medications, emergency contact information, next of kin, or vital signs

At step 6400, the actuation signal processing module 350 may signal the transmitter 380 to transmit the actuation signal and the emergency personnel member's data file to a communication device 140 located at a second location on the emergency personnel member. The process may then go to step 6500 and end.

FIG. 7 is an exemplary flowchart illustrating a possible emergency information transmission process in accordance with one possible embodiment of the disclosure. The process begins at step 7100 and continues to step 7200 where the receiver 480 may receive an actuation signal and an emergency personnel member's data file from a first location on the emergency personnel member at a second location on the emergency personnel member.

At step 7300, the communication processing module 450 may receive position information from the positional information receiver 250 concerning the emergency personnel member. At step 7400, the communication processing module 450 may calculate the emergency personnel member's position based on the received position information.

At step 7500, the communication processing module 450 may send a signal to the transmitter 240 to transmit the calculated emergency personnel member's position, the emergency personnel member's data file, and the actuation signal notification to an emergency response center 160. The actuation signal notification may be a simple or detailed notification based on the received actuation signal to the emergency response center 160 that an emergency situation has occurred and/or is in progress. The actuation notification signal and the emergency personnel member's data file may be transmitted by the transmitter 240 to the emergency response center 160 using cellular signals, for example. The process may then go to step 7600 and end.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the components of the disclosure each processing the content in various possible ways. It does not necessarily need to be one system used by all end users. Accordingly, the appended claims and their legal equivalents should only define the disclosure, rather than any specific examples given.

We claim:

1. A method for transmitting emergency information to a communication device, comprising:
receiving an actuation signal from an actuator button located at a first location on the emergency personnel member;
retrieving the emergency personnel member's data file from memory, the emergency personnel member's data file including personal identification information, emergency personnel unit identification, and at least one of, blood type, health information, allergies, health conditions, medical history, current medications, emergency contact information, next of kin, and vital signs; and
transmitting the actuation signal and the emergency personnel member's data file using a transmitter to the communication device located at a second location on the emergency personnel member.

2. The method of claim 1, wherein the first location is one of a belt, a vest and a wrist band.

3. The method of claim 1, wherein emergency personnel member's data files are loaded and updated in the memory through a universal serial bus (USB) port.

4. The method of claim 1, wherein the actuation signal and the emergency personnel member's data file are transmitted by the transmitter to the communication device using a bluetooth signal.

5. The method of claim 1, wherein the actuation signal and the emergency personnel member's data file are encoded by an encoder prior to transmission by the transmitter.

6. An apparatus that transmits emergency information to a communication device, comprising:
a memory that stores an emergency personnel member's data file, the emergency personnel member's data file including personal identification information, emergency personnel unit identification, and at least one of, blood type, health information, allergies, health conditions, medical history, current medications, emergency contact information, next of kin, and vital signs;
an actuator button pressable by the emergency personnel member;
a transmitter that transmits signals to the communication device; and
an actuation signal processing module that receives an actuation signal from the actuator button located at a first location on the emergency personnel member, retrieves the emergency personnel member's data file from the memory, and signals the transmitter to transmit the actuation signal and the emergency personnel member's data file to a communication device located at a second location on the emergency personnel member.

7. The apparatus of claim 6, wherein the first location is one of a belt, a vest and a wrist band.

8. The apparatus of claim 6, further comprising:
a universal serial bus (USB) that permits emergency personnel member's data files to be loaded and updated in the memory.

9. The apparatus of claim 6, wherein the actuation signal and the emergency personnel member's data file are transmitted by the transmitter to the communication device using a bluetooth signal.

10. The apparatus of claim 6, further comprising:
an encoder that encodes the actuation signal and the emergency personnel member's data file prior to transmission by the transmitter.

11. A method for transmitting emergency information from a communication device to an emergency response center, comprising:
receiving an actuation signal and an emergency personnel member's data file from a first location on the emergency personnel member at a second location on the emergency personnel member, the emergency personnel member's data file including personal identification information, emergency personnel unit identification, and at least one of, blood type, health information, allergies, health conditions, medical history, current medications, emergency contact information, next of kin, and vital signs;
receiving position information concerning the emergency personnel member;
calculating the emergency personnel member's position based on the received position information; and
transmitting the calculated emergency personnel member's position, the emergency personnel member's data file, and an actuation signal notification to the emergency response center.

12. The method of claim 11, wherein the first location is one of a vest, a boot, and an ankle bracelet.

13. The method of claim 11, wherein emergency personnel member's position is calculated using at least one of triangulation from signals received from cellular towers and global positioning system (GPS) signals.

14. The method of claim 11, wherein the actuation notification signal and the emergency personnel member's data file are transmitted to the emergency response center using cellular signals.

15. The method of claim 11, further comprising:
activating a vibration mechanism to vibrate upon receiving a test signal.

16. An apparatus that transmits emergency information from a communication device to an emergency response center, comprising:
a transmitter that transmits signals to an emergency response center;
a communications receiver that receives an actuation signal and an emergency personnel member's data file from a first location on the emergency personnel member at a second location on the emergency personnel member, the emergency personnel member's data file including personal identification information, emergency personnel unit identification, and at least one of, blood type, health information, allergies, health conditions, medical history, current medications, emergency contact information, next of kin, and vital signs;
a positional information receiver that receives position information concerning the emergency personnel member;
a communication processing module that receives position information concerning the emergency personnel member from the positional information receiver, calculates the emergency personnel member's position based on the received position information, and sends a signal to the transmitter to transmit the calculated emergency personnel member's position, the emergency personnel member's data file, and the actuation signal notification to an emergency response center.

17. The apparatus of claim 16, wherein the second location is one of a vest, a boot, and an ankle bracelet.

18. The apparatus of claim 16, wherein the communication processing module calculates the emergency personnel member's position using at least one of triangulation from signals received from cellular towers and global positioning system (GPS) signals.

19. The apparatus of claim 16, wherein the transmitter transmits the actuation notification signal and the emergency personnel member's data file to the emergency response center using cellular signals.

20. The apparatus of claim 16, further comprising:
a vibration mechanism that vibrates upon receiving a test signal.

21. A system that transmits emergency information to an emergency response center, comprising:
an actuator unit located at a first location on an emergency personnel member, comprising:
a memory that stores an emergency personnel member's data file, the emergency personnel member's data file including personal identification information, emergency personnel unit identification, and at least one of, blood type, health information, allergies, health conditions, medical history, current medications, emergency contact information, next of kin, and vital signs;
an actuator button pressable by the emergency personnel member;
a first transmitter that transmits signals to a communication device; and
an actuation signal processing module that receives an actuation signal from the actuator button, retrieves the emergency personnel member's data file from the memory, and signals the first transmitter to transmit the actuation signal and the emergency personnel member's data file to a communication device located at a second location on the emergency personnel member,
wherein the communication device comprises:
a second transmitter that transmits signals to an emergency response center;
a communications receiver that receives an actuation signal and an emergency personnel member's data file;
a positional information receiver that receives position information concerning the emergency personnel member; and
a communication processing module that receives position information concerning the emergency personnel member from the positional information receiver, calculates the emergency personnel member's position based on the received position information, and sends a signal to the second transmitter to transmit the calculated emergency personnel member's position, the emergency personnel member's data file, and an actuation signal notification to the emergency response center.
